(19) United States
(12) Patent Application Publication
(10) Pub. No.: US 2019/0190898 A1
(43) Pub. Date: Jun. 20, 2019

(54) METHODS AND SYSTEMS FOR MANAGING INTERNET PREFERENCES

(71) Applicant: Microsoft Technology Licensing, LLC, Redmond, WA (US)

(72) Inventor: Dan Cui, Sammamish, WA (US)

(21) Appl. No.: 15/846,939

(22) Filed: Dec. 19, 2017

(51) Int. Cl. H04L 29/06; G06F 17/30; H04L 29/08

(52) U.S. Cl. CPC H04L 63/06; H04L 63/083; H04L 67/306; H04L 67/36; H04L 67/02; G06F 17/30884

(57) ABSTRACT

Methods, systems, and apparatuses for managing internet preferences include a personal portal web service with a preferred website uploader that uploads internet preferences such as bookmark data that identifies preferred websites for a user on a remote device. A data store stores the internet bookmark data and a graphical user interface is generated that enables the user to connect to the preferred websites specified by the internet bookmark data. An authentication data store stores authentication data such as usernames and passwords for websites that the user accesses. A credential applier automatically enters the authentication data into an application accessed through the graphical user interface of the personal portal. The personal portal web service can be set up to function as a home page for the user and accessed from any type of web browser or device. Restricted access is provided to data collected concerning usage of the service.

### BACKGROUND

People access internet resources via many different devices such as smart phones, tablets, televisions (TVs), personal computers (PCs), laptops, etc. In addition to using different devices, people often use different web browsers such as Microsoft® Edge® (published by Microsoft Corporation, of Redmond, Wash.), Internet Explorer® (also published by Microsoft Corporation of Redmond, Wash.), Firefox® (published by Mozilla of Mountain View, Calif.), Safari® (published by Apple, Inc. of Cupertino, Calif.), Chrome™ (published by Google, Inc. of Mountain View, Calif.), etc. Internet bookmarks are a popular tool for providing quick access to web pages that users frequently visit. However, internet bookmarks are specific to a particular device or web browser. Thus, a person typically has access to different internet bookmarks on different devices, or even when accessing the web through a different web browser on the same device. It is inconvenient and time consuming to maintain multiple sets of internet bookmarks across different devices and platforms. These internet bookmarks cannot be easily managed and shared when crossing platforms and are dependent upon accessing the internet through a particular device or browser.

In addition, many internet websites or resources require a user to enter authentication data to obtain access to the content. Keeping track of numerous different user identifications and passwords among different devices is troublesome and difficult. While some web browsers save user names and authentication data, this information is only accessible when using that particular web browser. Like internet bookmark data, the storage of this authentication data is browser and device dependent. This can easily result in a user not having access to their information in some circumstances, which can be very inconvenient for the user.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and apparatuses for managing internet preferences are described herein. In accordance with embodiments, such methods, systems, and apparatuses include a personal portal web service with a preferred website uploader that uploads, from a remote device, internet preferences such as bookmark data that identifies preferred websites for a user of the remote device. A data store stores the internet bookmark data and a graphical user interface (e.g., in the form of a web page) is generated that enables the user to connect to the preferred websites specified by the internet bookmark data. In accordance with further embodiments, an authentication data store stores authentication data such as usernames and passwords for websites that the user accesses. In further accordance with such an embodiment, a credential applier may automatically enter the authentication data into an application accessed through the graphical user interface of the personal portal. In accordance with some embodiments, the personal portal web service can be set up to function as a home page for the user and accessed from any type of browser or device. In still further embodiments, restricted access is provided to data collected concerning usage of the service.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a cloud-based system in accordance with an example embodiment;

FIG. 2 shows a graphical user interface for a personal portal web service in accordance with an example embodiment;

FIG. 3 shows program logic for a personal portal web service in accordance with an example embodiment;

FIG. 4 is a flowchart of a method of providing a personal portal web service in accordance with an example embodiment;

FIG. 5 is a flowchart of a method of providing a personal portal web service for anonymous and verified users in accordance with an example embodiment;

FIG. 6 is a flowchart of a method of updating and synchronizing bookmark data on a personal portal web service in accordance with an example embodiment;

FIG. 7 is a flowchart of a method of managing authentication data through a personal portal web service in accordance with an example embodiment;

FIG. 8 is a flowchart of a method of collecting, storing and providing access to usage data for a personal portal web service in accordance with an example embodiment;

FIG. 9 is a flowchart of a first use case scenario for the use of a personal portal web service in accordance with an example embodiment;

FIG. 10 is a flowchart of a second use case scenario for the use of a personal portal web service in accordance with an example embodiment;

FIG. 11 is a flowchart of a third use case scenario for the use of a personal portal web service in accordance with an example embodiment;

FIG. 12 is a flowchart of a fourth use case scenario for the use of a personal portal web service in accordance with an example embodiment;

FIG. 13 is a flowchart of a fifth use case scenario for the use of a personal portal web service in accordance with an example embodiment; and

FIG. 14 is an example of a system for implementing an embodiment.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### Introduction

The present specification and accompanying drawings disclose one or more embodiments that incorporate some of the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

The embodiments are directed toward solving a number of issues and challenges facing internet users. The vast majority of internet users regardless of age and profession have preferred resources on the internet that they like to visit frequently. Most of the time people use internet bookmarks or index files to save a list of preferences for quick access. However, there are several challenges presented when managing these lists. As discussed above, browser dependency is one such problem. Each browser has its own set of bookmarks and there is currently no effective manner of synchronizing them between different browsers. Another such problem is device dependency. Most individuals have more than one type of device. Different types of devices such as PCs, mobile phones, tablets, are unable to share user preferences such as internet bookmarks. A similar problem exists between different models of the same device. The problem is that one bookmark or index file cannot be accessed from all the different devices and, thus, separate copies are stored in each device.

Internet users also often access or connect to multiple applications and services via various networks. None of the current bookmark platforms have features to support an easy or short access process to a local or remote resource that requires authentication. As a result of the need for security, most internet users also have a large number of different credentials to manage. Often, a user cannot remember their username and password for a particular website, especially if they are for website the user has not visited for a while. Prior to the present disclosure, there was not a single effective solution to managing these bookmarks, internet preferences, information and credentials.

### Example Embodiments

The example embodiments described herein are provided for illustrative purposes, and are not limiting. The examples described herein may be adapted to any type of web service. Further structural and operational embodiments, including modifications/alterations, will become apparent to persons skilled in the relevant art(s) from the teachings herein.

With the above objects in mind, an embodiment is directed toward a personal portal web service hosted in the cloud. The personal portal web service can be initiated by uploading a personal bookmark file or be created manually through the hosted web service if a user prefers to start with a blank page. Once the bookmark files have been uploaded to the personal portal web service, they can be accessed from any device or platform through the portal.

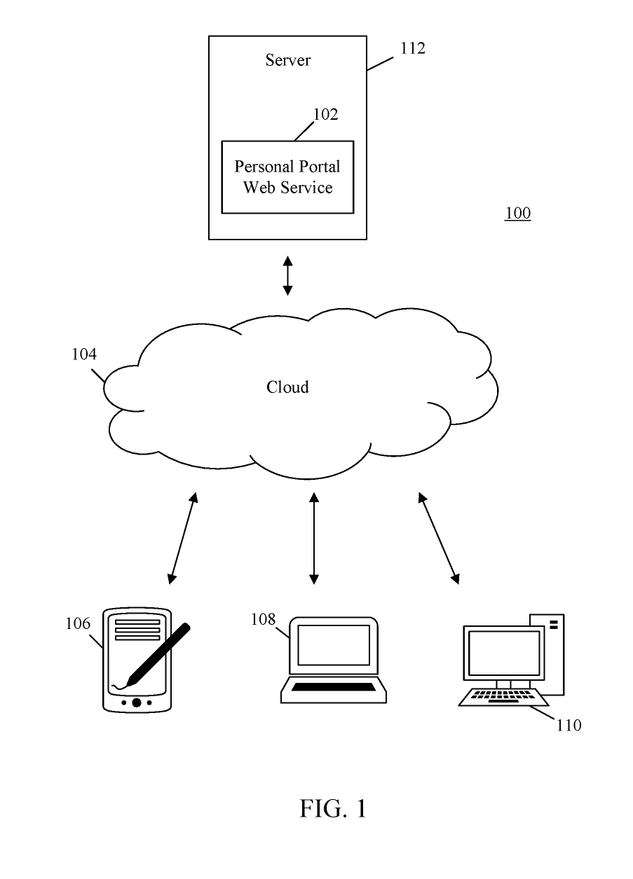

FIG. 1 shows a cloud-based system 100 in accordance with an example embodiment. The basic structure of the system includes a personal portal web service 102 hosted on a server 112 in a cloud 104. Personal portal web service 102 provides a centralized platform for the storage and management of bookmarks, index files, internet preferences, remotely accessed applications and resource feeds. Hosting personal portal web service 102 on server 112 in cloud 104 helps to provide a consistent user experience regardless of the device or platform from which it accessed.

Personal portal web service 102 is shown in FIG. 1 as part of cloud 104 which is a network of remote servers hosted on the Internet that is used to store, manage, and process data in place of local servers or personal computers. However, personal portal web service 102 and server 112 need not be hosted in the cloud, and may instead comprise part of any suitable network (e.g., an enterprise network, local area network, or the like) and accessed by client devices connected to such network. Since personal portal web service 102 of FIG. 1 is cloud-based (or network-based), personal portal web service 102 may provide a consistent user experience regardless of the particular type of device accessing the service or the web browser or software running on the device.

Personal portal web service 102 can connect to variety of different platforms such as a mobile phone 106, a laptop 108, a personal computer 110, etc. The content stored in personal portal web service 102 is in cloud 104 and not stored in remote devices 106, 108 and 110 and is not device dependent. While the embodiment of FIG. 1 is cloud-based (or network-based), embodiments can also be application-based as will be discussed in more detail herein.

The features of personal portal web service 102 of FIG. 1 are accessed through a graphical user interface (e.g., a web page or other network-accessed graphical user interface) which allows a user to connect to the preferred websites and resources specified in their account or otherwise stored on their behalf. The graphical user interface can be organized in accordance with a variety of different themes from which a user can select. Preferred websites can be connected to from within the personal portal web service by clicking on a link or bookmark displayed on the graphical user interface.

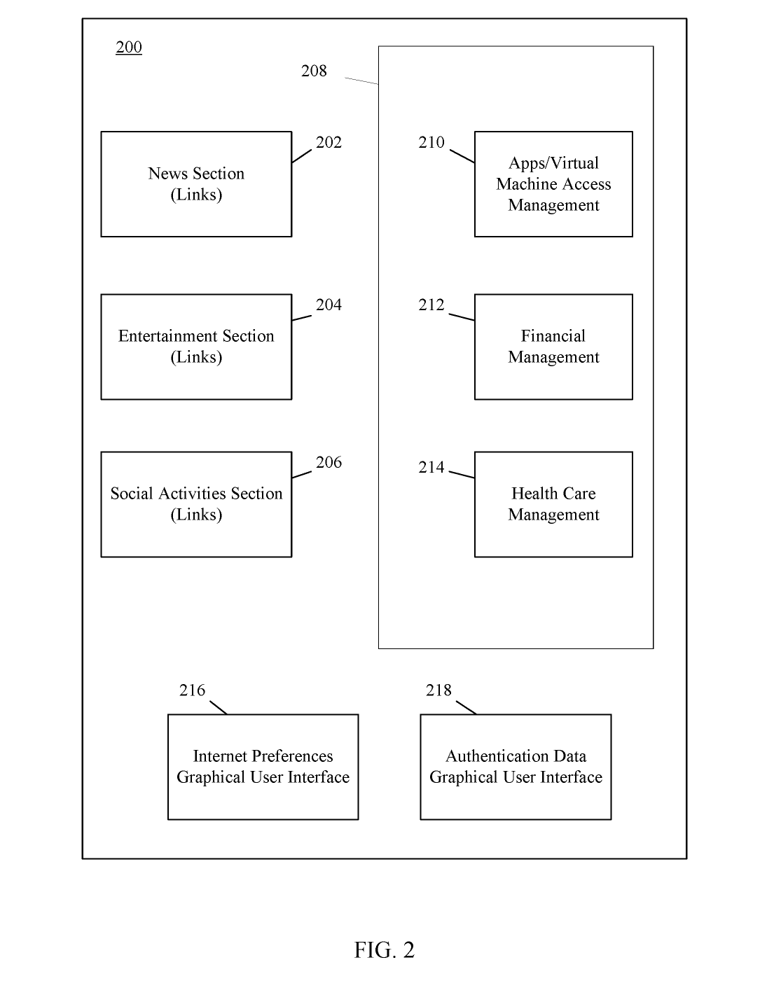

FIG. 2 shows a graphical user interface 200 for a personal portal web service in accordance with an example embodiment. Graphical user interface 200 allows a user to connect to preferred websites or resources by clicking on icons, links, or other suitable user-interactive controls. As shown in FIG. 2, the user-interactive controls may be logically partitioned into sections that link to unrestricted websites such as a news section 202, an entertainment section 204 and a social activities section 206 that do not require authentication credentials to access, and a restricted access section 208 that includes links to resources that require authentication such as remote applications and virtual machine access management 210, financial management 212 and health care management 214. For example, if a user clicks on a link in news section 202, the user will immediately be connected to the link through the personal portal web service. In contrast, if a user clicks on a link in restricted access section 208, the user may be required to enter authentication data to obtain access to the resource specified by the link. In accordance with certain embodiments that will be further described herein, to facilitate the provision of such authentication data, graphical user interface 200 of the personal portal web service may either display, or automatically enter, any authentication data required by a link before connecting the user to the resource specified by the link.

As discussed in more detail herein, the user can manage and update the links and resources included within sections 202, 204, 206 and 208 displayed on graphical user interface 200. In one embodiment, an internet preferences graphical user interface 216 is provided in graphical user interface 200 that allows a user to manually enter internet preferences data that identifies preferred websites or remotely hosted applications for the user. An authentication data graphical user interface 218 may also be provided within graphical user interface 200 that allows a user to enter and modify user authentication data for a website or remotely hosted application. Although internet preferences graphical user interface 216 and authentication data graphical user interface 218 are shown in FIG. 2 as being part of the same graphical user interface as sections 202, 204, 206 and 208, it is to be understood that such elements may be distributed across several graphical user interfaces (e.g., across several web pages), each of which is accessible to the user. Furthermore, although a particular graphical theme for graphical user interface 200 is shown in FIG. 2, it is to be understood that other graphical themes may be used that organize controls associated with various websites and resources in different ways or that provide access to different websites and resources. In an embodiment, the user can select between a variety of different themes for the graphical user interface or create their own themes.

The personal portal web service can be implemented through program logic that is executed by a processor. For example, the program logic could be stored in, and executed by, one or more processors of server 112 of FIG. 1. The particular form and arrangement of the program logic will depend upon the platform or operating system which is used to implement the web service and the features included thereby.

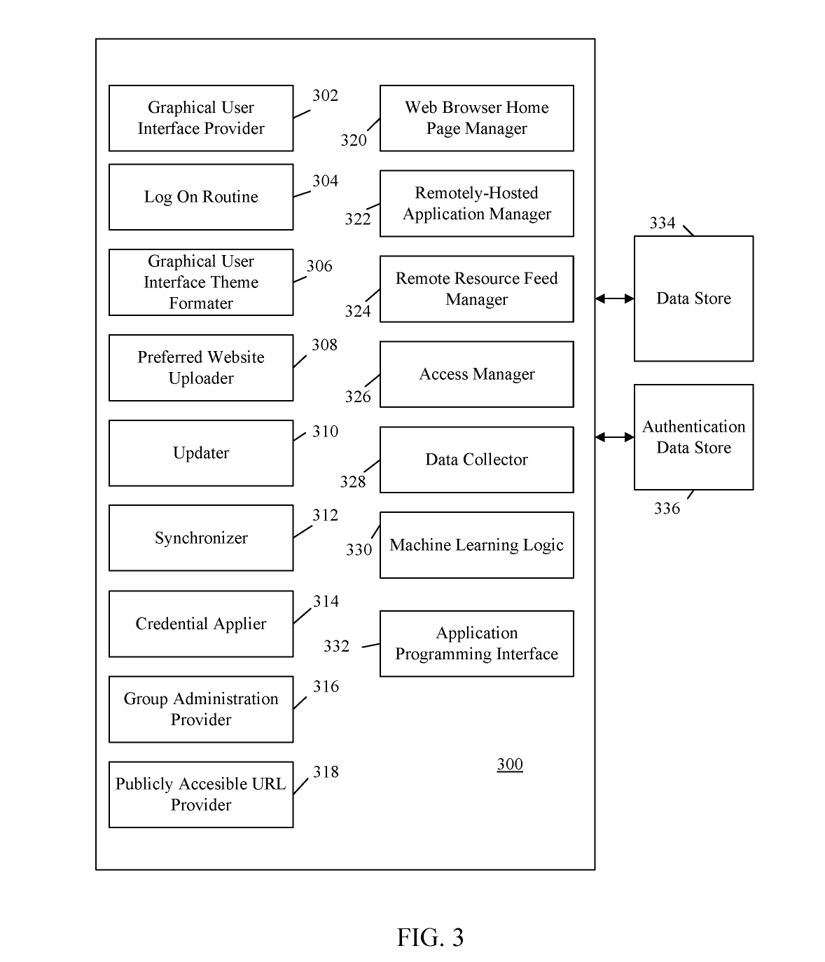

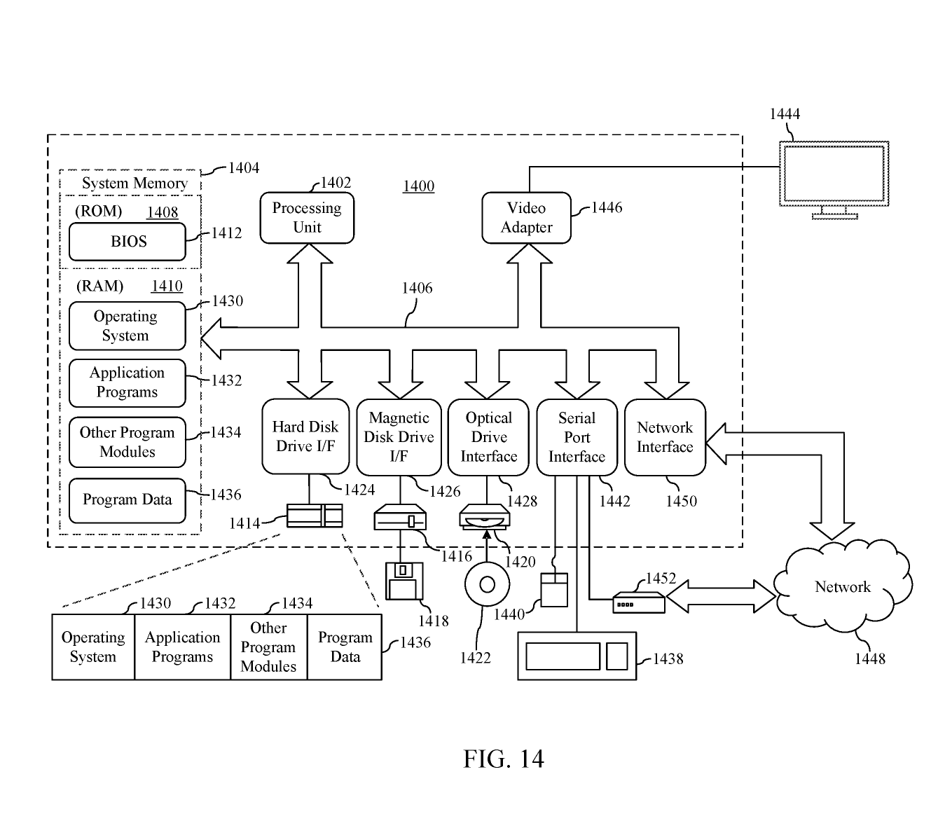

FIG. 3 shows program logic 300 for a personal portal web service in accordance with an example embodiment. Program logic 300 is stored in at least one memory (e.g., at least one memory device or storage system) and executed by at least one processor configured to access the memory as described in more detail below with respect to FIG. 14. Program logic 300 includes a graphical user interface provider 302 that provides a graphical user interface that enables a user to connect to preferred websites specified by internet bookmark data stored in a data store 334 that is accessible by program logic 300. The graphical user interface also enables the user to access remotely-hosted applications through a remotely-hosted application manager 322 or resource feeds through a remote resource feed manager 324 associated with a user account. The graphical user interface is organized in accordance with a graphical user interface theme that specifies a logical layout for the graphical user interface. A graphical user interface theme formatter 306 allows a user to select from among a plurality of graphical user interface themes. In an embodiment, the interface themes can be customized if desired. A web browser home page manager 320 is configured to allow the graphical user interface to function as a home page for a web browser on a device of a user such that all internet access for the user is through the personal portal web service.

A log on routine 304 receives and verifies log on information for a user account associated with the user and logs the user into the user account. The log on information received by the log on routine 304 may include, for example and without limitation, a username and password that respectively identify and restrict access to a user account. If a user wants to use the personal portal service anonymously (i.e., without establishing a user account), a publicly accessible URL provider 318 can be used to generate a publicly accessible URL that can be used to access the personal portal service without the need to enter credentials. The anonymous user can then establish a set of internet preferences through the personal portal web service that can be accessed through the generated URL.

A preferred website uploader 308 uploads internet bookmark data containing internet preferences such as internet bookmark data for a user from a remote device and stores the internet bookmark data in data store 334. An updater 310 allows the user to make modifications and changes in the internet bookmark data directly through a graphical user interface. New bookmarks can be manually added to or deleted from the user's account (or publicly accessible URL) using the updater 310. In addition, a synchronizer 312 may be used to automatically synchronize the internet bookmark data stored in data store 334 with internet bookmark data stored on the user's remote device.

Program logic 300 may also be access an authentication data store 336 that stores user authentication data for the user. The graphical user interface provided by graphical user interface provider 302 may be operable to display the authentication data on demand when a user is logged on to their user account. If desired, a credential applier 314 can be configured to automatically enter authentication data into a remote application or website accessed by a user through the personal portal web service.

A group administration provider 316 enables a group administrator to provide group access to a particularly configured web portal through the graphical user interface. This enables enterprise or group administrative users to build a private portal page so that group members can easily access shared resources from any type of device or web browser. Access control can be switched on or off for whole or partial contents of the group portal depending on the user's nature and credentials and content can be entirely or partially shared among authorized users.

An access manager 326 provides restricted access to additional statistical and analysis data compiled by the personal portal to privileged users such as paying or advanced users. This group of users have access to personal portal statistics and other data collected by the personal portal service. This group of users also preferably have access to personal portal software developer kits or an application programming interface 332 that can help them build additional pages, features and reports. Application programming interface 332 can also be used to render reports generated based upon areas selected and/or defined by users. The data is generated by a data collector 328 that collects and stores statistical data concerning use of the personal portal web service that can then be accessed by advanced users with advanced access credentials. The statistical data may have any personal identification data removed by data collector 328 such that reports are rendered with only aggregated data. Machine learning logic 330 is used to analyze the data, provide trend information, make recommendations, and help generate potential feature requests.

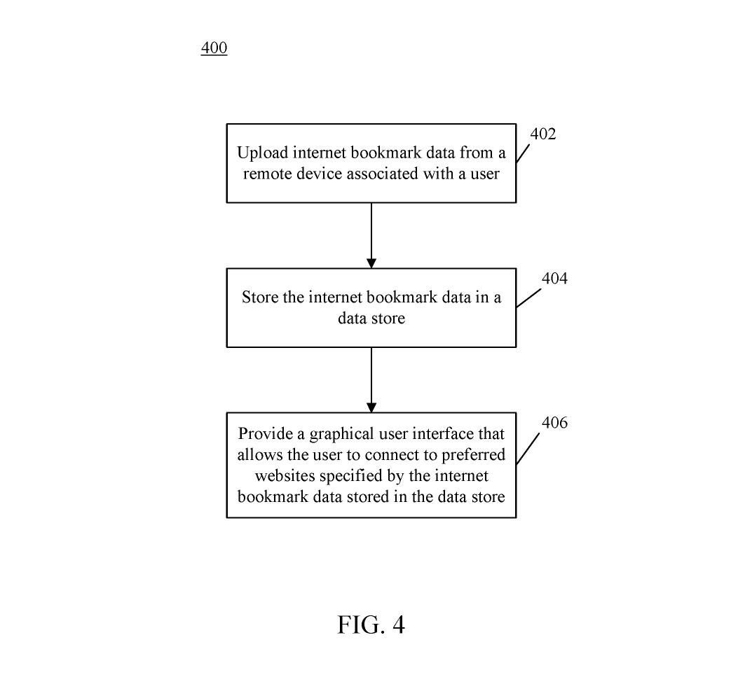

The personal portal web service may be implemented through the performing of a number of operations or functions for a user of the service. FIG. 4 is a flowchart 400 of a method of providing a personal portal web service in accordance with an example embodiment. Flowchart 400 begins in step 402 with the uploading of internet bookmark data from a remote device associated with a user to the personal portal web service. The internet bookmark data can be entered directly by a user of the system or automatically uploaded from a bookmark file stored on the user's device. The uploaded internet bookmark data may identify favorite websites or locations that the user has accessed with the remote device. Step 402 of FIG. 4 could be implemented, for example, by preferred website uploader 308 of FIG. 3 or personal portal web service 102 of FIG. 1.

The uploaded internet bookmark data is stored in a data store in step 404 of flowchart 400. The data store preferably exists in the cloud (or other network-accessible location) and is used to maintain a list of internet preferences for a user that provides quick access to the resources and is consistent regardless of the device or platform from which the list is accessed. Step 404 of FIG. 4 could be implemented, for example, by data store 334 of FIG. 3 or personal portal web service 102 of FIG. 1.

A graphical user interface that allows the user to connect to preferred websites or other internet resources specified by the internet bookmark data stored in the user preferences data store is provided in step 406. The graphical user interface displays links and connections to the preferred websites and automatically connects the user to the associated websites when the user clicks on the link. The format or theme of the graphical user interface can be selected from one of a number of predefined themes or customized by the user to satisfy their individual tastes. Step 406 of FIG. 4 could be implemented, for example, by graphical user interface provider 302 of FIG. 3 or personal portal web service 102 of FIG. 1.

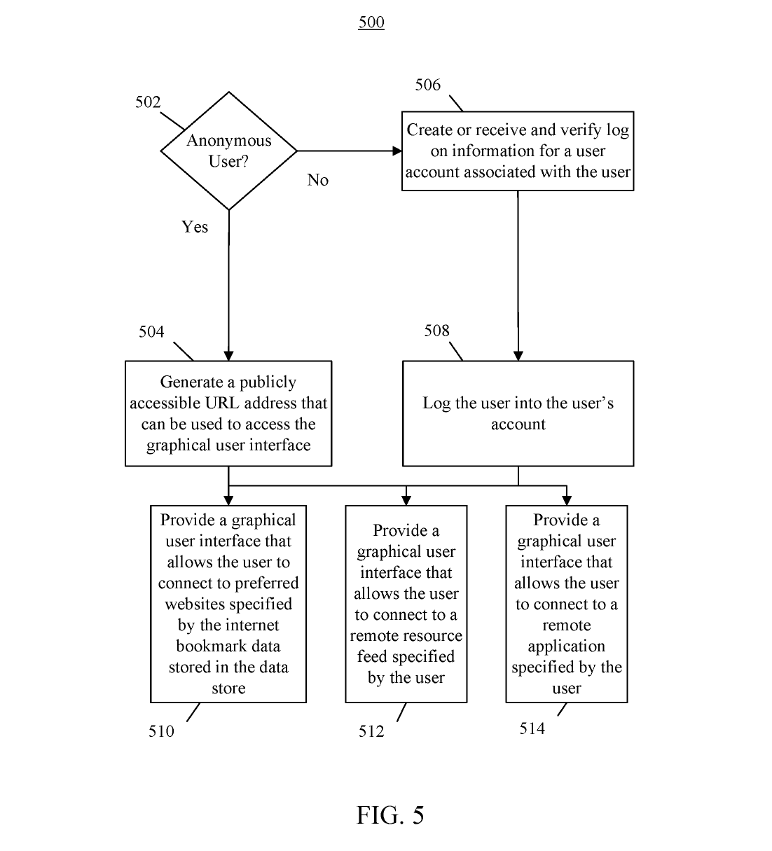

Users of the personal portal web service may want to create a verified user account that requires a username and password to access or an anonymous portal that does not require any identifying information to access. FIG. 5 is a flowchart 500 of a method of providing access to a personal portal web service for anonymous and verified users in accordance with an example embodiment. Flowchart 500 begins in step 502 wherein it is determined if the user wants to be an anonymous user or not. Graphical user interface provider 302 of FIG. 3 could be used to perform step 502 by producing a graphical user interface that prompts the user to pick either an anonymous or verified user account.

If the user wants an anonymous portal, the method proceeds to step 504 and a publicly accessible URL is generated that can be used to access the graphical user interface of the anonymous portal. Anyone that has the URL address can the access the preferred websites identified by the links on the web page accessed through the URL address. Anonymous web pages that were set up but that have not been accessed within a set period of time can be automatically removed to conserve system resources. Publicly accessible URL provider 318 of FIG. 3 could be used to perform step 504 by generating the URL address.

If the user wants or has a log on account, the method proceeds to step 506 wherein log on information for a user account from a user on remote devices is either created or received and verified. If the user does not yet have an account established, the user is prompted to enter their desired log on information such as a username and password or provided log on information by the personal portal web service. Requiring log in information prevents unauthorized individuals from seeing the preferred websites and any other data contained in the account of a verified user. Once the log in information has been received and verified in step 506, the method proceeds to step 508 wherein the user is logged into their personal portal account. Log on routine 304 of FIG. 3 can be used to perform step 506 by prompting a user enter their log on information and verifying the entered information.

Once the user has either generated a publicly accessible URL for an anonymous web page as shown in step 504 or logged into their account in step 508, the user can access a number of resources through the personal portal web services by simply clicking on a link displayed on the graphical user interface of the portal. In step 510, a graphical user interface is provided that allows the user to connect to preferred websites specified by the internet bookmark data stored in the data store. This data may have been uploaded from the user's device or directly entered into the personal portal by the user. The websites specified by the internet bookmark data stored in the data store will remain the same regardless of the type of device or web browser from which the portal is accessed. Graphical user interface provider 302 of FIG. 3 can be used to perform step 510 by producing a graphical user interface that allows a user to connect to preferred websites specified by the internet bookmark data stored in the data store.

In step 512 of flowchart 500, a graphical user interface is provided that allows the user to connect to a remote resource feed specified by the user. The remote resource feed may be hosted on any suitable remote platform, including but not limited to cloud services platforms such as Microsoft® Azure®, Amazon Web Services™, or Google Cloud Platform™. The graphical user interface may contain links that a user can click on to access the remote resource feeds. Graphical user interface provider 302 of FIG. 3 could be used to perform step 512 by producing a graphical user interface that allows a user to connect to the remote resource feeds specified by the user through the personal portal web service.

In step 514 of flowchart 500, a graphical user interface is provided that allows the user to connect to a remote application specified by the user. The remote application may be hosted on any suitable remote platform, including but not limited to cloud services platforms such as Microsoft® Azure®, Amazon Web Services™, or Google Cloud Platform™. The graphical user interface may contain links that a user can click on to access the remote applications. Graphical user interface provider 302 of FIG. 3 can be used to perform step 514 by producing a graphical user interface that allows a user to connect to the remote application specified by the user.

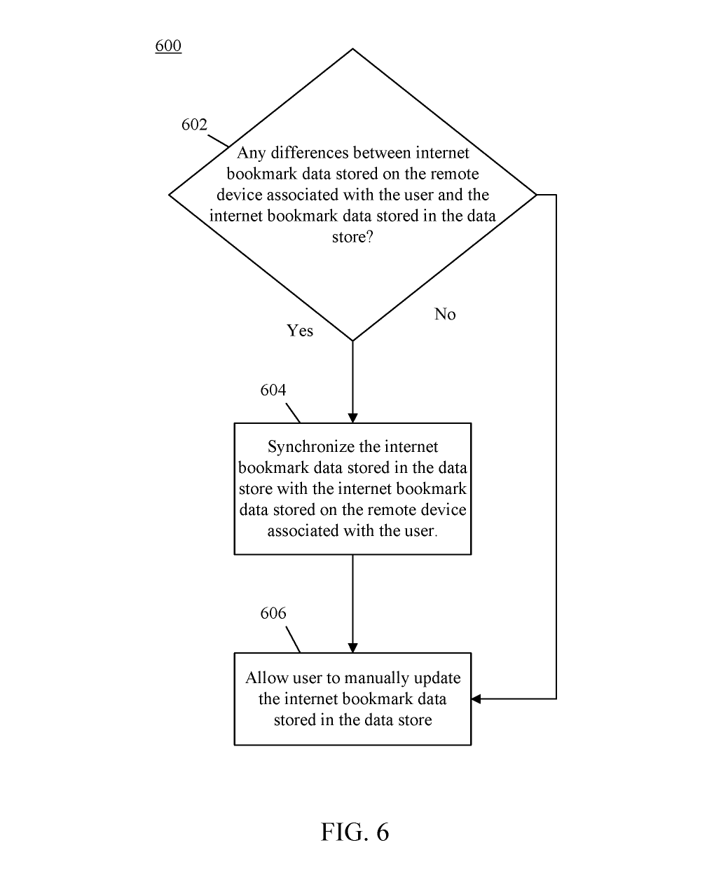

FIG. 6 is a flowchart 600 of a method of updating and synchronizing bookmark data on a personal portal web service in accordance with an example embodiment. A user may want to synchronize any preferences on the device that they are using with the preference data stored in the data store of the personal portal web service so that the portal contains the latest version of the preferences. The user may also want to manually add new preferences to their personal portal.

Accordingly, once the user is connected to the personal portal web service, it is determined in decision step 602 if any differences exist between the internet bookmark data stored on the user's remote device and the internet bookmark data stored in the data store. This can be accomplished by comparing the internet bookmark file on the remote device with the internet bookmark file stored in association with the user's account. Updater 310 of FIG. 3 may be used to perform step 602 of flowchart 600.

If there are any differences between the internet bookmark data stored on the remote device associated with the user and the internet bookmark data stored in the data store, the method proceeds to step 604 in which the internet bookmark data stored in the data store is automatically synchronized with the internet bookmark data on the remote device. The user can preferably set the synchronization parameters such as whether to simply match the data on the personal portal web service with the data on the device or to add any new internet bookmarks stored on the device to the internet bookmarks stored in the data store of the portal.

If there are no differences between the internet bookmark data stored on the remote device associated with the user and the internet bookmark data stored in the data store in step 602 or the internet bookmark data stored in the data store has been synchronized with the internet bookmark data on the remote device in step 604, the method proceeds to step 606 wherein the user is allowed to manually update the internet bookmark data stored in the data store. The user preferably can enter the updates through a graphical user interface that allows the user to view and modify the current internet bookmark data. Step 606 could, for example, be performed by updater 310 of FIG. 3 or the personal portal web service 102 of FIG. 1.

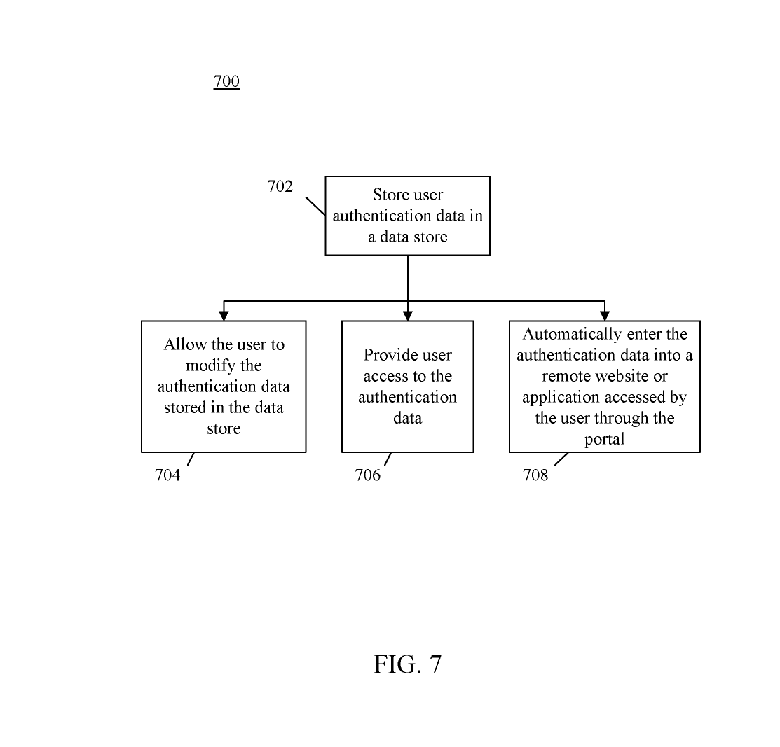

The personal portal web service also allows a user to store, access and manage the authentication data, such as usernames and passwords, required to access restricted access websites, services or resources. To ensure security of the authentication data, even a logged-in user may be required to verify their credentials again or validate their identity through multi-factor authentication to access the authentication data. When a user accesses a restricted web resource that requires authentication data through the personal portal web service, the personal portal web service may either display or automatically enter the required authentication data. FIG. 7 is a flowchart 700 of a method of managing authentication data through a personal portal web service in accordance with an example embodiment.

Flowchart 700 of FIG. 7 begins in step 702 with the storing of authentication data for a user in a data store. This authentication data may include, for example and without limitation, a username and password that must be entered before a particular web resource can be accessed. The authentication data for multiple different websites or resources can be stored in the personal portal web service data store. Once the user has stored their authentication data in the data store of the personal portal web service, the authentication data will remain consistent regardless of the type of device or web browser from which it is accessed.

After the authentication data for a user has been stored in the data store, the user can proceed to step 704 of the flowchart 700 of FIG. 7 wherein the user is allowed to modify to the authentication data stored in the data store. This allows the user to update their authentication data if it has changed or correct any erroneously entered data. The authentication data can, for example, be stored in authentication data store 336 of FIG. 3.

As shown in step 706 of flowchart 700, the user is provided access to the authentication data stored in the data store upon request. This allows the user to see their authentication data and manually enter the data if needed. As the authentication data is centrally stored and managed, the user can access the data from any type of device or browser. Even if a user purchases a brand new device, when they log on to the personal portal web service, their authentication data will remain unchanged and not need to be reentered. As an example, graphical user interface provider 302 and authentication data store 336 of FIG. 3 can be used to perform step 706 of flowchart 700.

As shown in step 708 of flowchart 700, once the user has stored their authentication data in the data store, the personal portal web service can automatically enter the authentication data into a remote website or application accessed by the user through the portal if desired. The eliminates the need to reenter the authentication data every time a user visits a restricted website. Furthermore, if the user is logged into the personal portal web service, the authentication data is available and can be automatically entered regardless of the device or browser used to access the portal. As an example, credential applier 314 of FIG. 3 or personal portal web service 102 of FIG. 1 can be used to perform step 708 of flowchart 700.

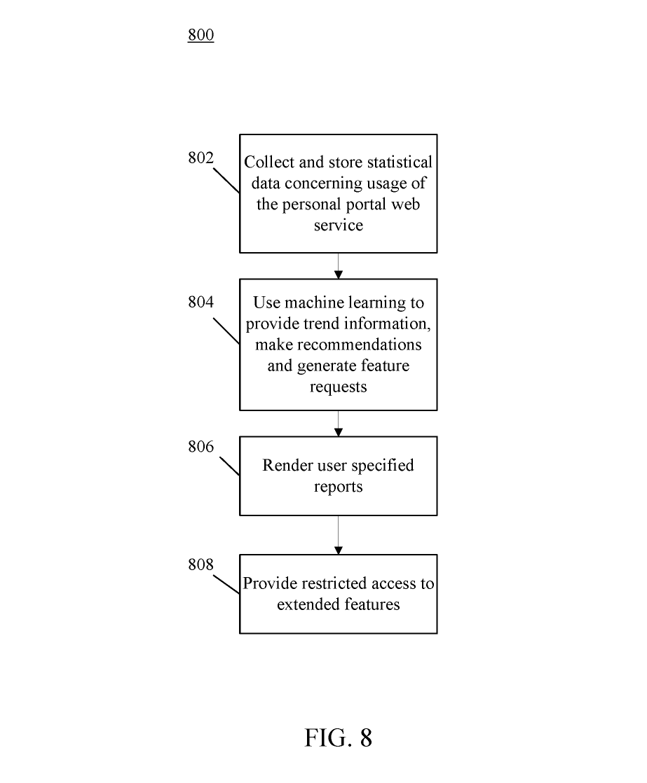

Statistical information concerning use of the personal portal web service is preferably collected and made available to advanced or paid users. This information may be used for functions such as targeted advertising, rendering reports, providing trend information, making recommendations, and generating potential feature requests. For example, if a user frequently visits certain websites, machine learning can be used to learn the user's interests and make recommendations for similar websites or related products based on the learned user interests. An example of a generating potential feature request is that user behaviors, like updating their bookmark data using non-English characters (e.g. DBCS or BIDI), can be used to indicate international users and markets that need to be supported if currently not. Thus, localizing the portal into different languages may be a new feature request generated. Another example is that, if most of the connections to certain web sites are coming from mobile devices, this statistical data may be used to direct more investment on mobile device support versus other device support. FIG. 8 is a flowchart 800 of a method of collecting, storing and providing access to usage data for a personal portal web service in accordance with an example embodiment.

Flowchart 800 of FIG. 8 begins in step 802 with the collecting and storing of statistical data concerning use of the personal portal web service, which may include use of the various graphical user interfaces provided to various users by the personal portal web service. The statistical data may concern usage parameters such as the websites visited through the portal, the amount of time spent on each website, the amount of time spent on the portal, etc. As an example, data collector 328 of FIG. 3 or personal portal web service 102 of FIG. 1 can be used to perform step 802 of flowchart 800.

Machine learning is used in step 804 of flowchart 800 to provide trend information concerning usage of the system, make recommendations and generate feature requests. The trend information may be a list of the most commonly visited websites in a certain time period (e.g., during the last week) or a computation of an average amount of time spent on the personal portal web service by users. Machine learning can also be used to monitor users' behavior on the personal portal web service to identify potential new features that may be useful to users of the service and make recommendations regarding websites that may be of interest. Step 804 can, for example, be performed by machine learning logic 330 of FIG. 3 or personal portal web service 102 of FIG. 1.

The method of flowchart 800 includes step 806 wherein user specified reports are rendered. These reports may contain user-specified categories of information and may be rendered upon the request of the user. An application programming interface may be provided by to allow application developers and other users to specify the content of the reports and customize their generation. Step 806 could, for example, be performed using application programming interface 332 of FIG. 3 or personal portal web service 102 of FIG. 1.

In step 808 of the method of flowchart 800, restricted access is provided to the extended data and features provided by steps 802, 804 and 806. Access can be limited to paid customers or subscribers to a data plan that have the appropriate credentials. As noted above, an application programming interface can be provided to these advanced users to enable such users to build applications that access the data, compile reports and/or apply new or customized themes to their portal page. Step 808 could, for example, be performed by graphical user interface provider 302 and log on routine 304 of FIG. 3 or personal portal web service 102 of FIG. 1.

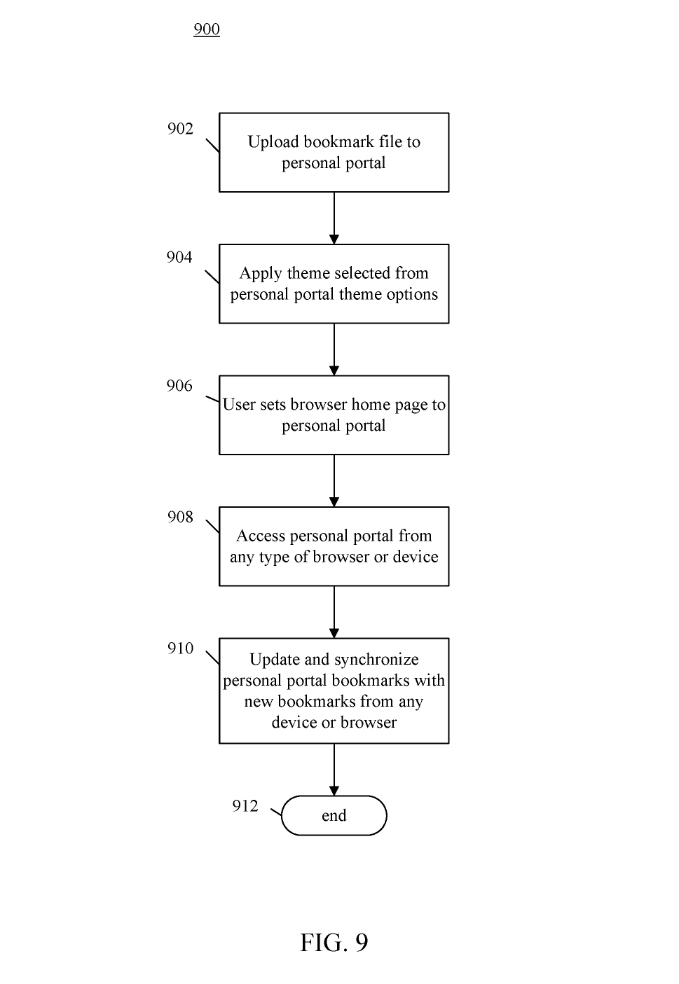

FIG. 9 is a flowchart 900 of a first use case scenario for the use of a personal portal web service in accordance with an example embodiment. Flowchart 900 begins in step 902 with the uploading of an internet bookmark file to the personal portal. For example, the internet bookmark file may be comprise a web browser bookmark file associated with one of Microsoft® Edge®, Internet Explorer®, Firefox®, Safari®, or Chrome™. In step 904, a theme selected by the user from a set of personal portal theme options is applied to the graphical user interface. The user then sets their browser home page to the personal portal page in step 906. As shown in step 908, the user can access their personal portal from any type of browser or device. While on the personal portal, the user can also update and synchronize their personal portal bookmarks with new bookmarks from any of their devices or web browsers without regard to type or model as shown in step 910 of flowchart 900. Flowchart 900 of FIG. 9 ends in step 912 when the user logs off the personal portal web service.

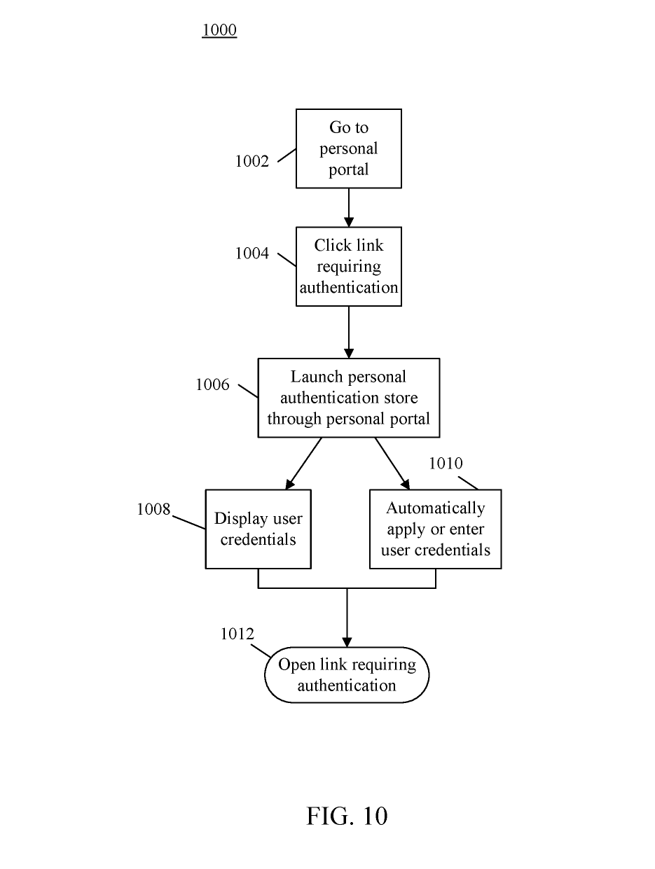

FIG. 10 is a flowchart 1000 of a second use case scenario for the use of a personal portal web service in accordance with an example embodiment. Flowchart 1000 begins with the user going to the personal portal in step 1002. In step 1004, the user clicks on a link to a resource or website that requires authentication. The personal authentication store is then launched through the personal portal in step 1006. Depending upon the user's preferences, the method then proceeds to either step 1008 where the user credentials are displayed on a graphical user interface or to step 1010 wherein the user credentials are automatically applied or entered into the link that requires authentication. The use case scenario of flowchart 1000 ends in step 1012 with the opening of the desired link that required authentication. The example flowchart 1000 of FIG. 10 demonstrates how the personal portal can be very useful to individuals that have trouble managing or remembering their username and/or password.

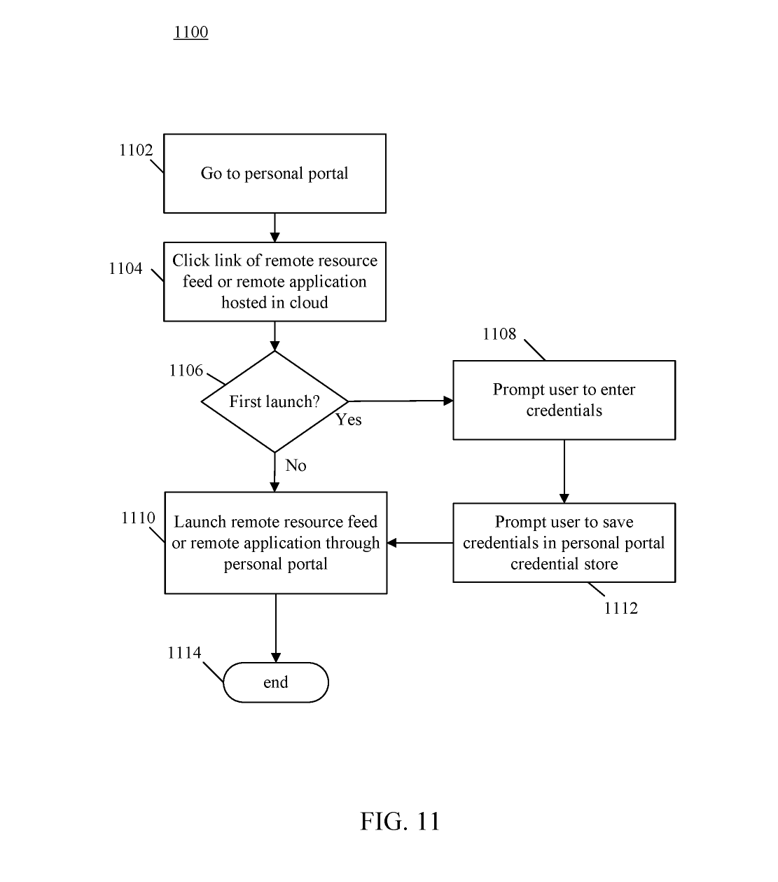

FIG. 11 is a flowchart 1100 of a third user case scenario for the use of a personal portal web service in accordance with an example embodiment. Flowchart 1100 of FIG. 11 begins with the user going to the personal portal in step 1102. Once on the personal portal, the user can click the link of a remote resource feed or a remote application hosted by a remote entity, such as by a remote cloud services platform such as Microsoft® Azure®, Amazon Web Services™ or Google Cloud Platform™ in step 1104. In decision step 1106, it is determined if it is the first time that the user has launched the remote resource feed or application. If it is determined that this is the first time that the user has launched the link and the link requires the entry of user credentials, the method proceeds to step 1108 wherein the user is prompted to enter their credentials. In step 1112, the user is prompted to save their credentials in a personal portal credential store. The user has the option to not save their credentials in the personal portal credential store, in which case, regardless of whether it is the first launch, the user is always expected to enter their credentials to access a resource that requires authentication through the portal. The scenario then proceeds to step 1110 wherein the remote resource feed or remote application is launched through the personal portal. If the link does not require credentials or has been previously launched, the method proceeds directly from step 1106 to step 1110. In this scenario, any required credentials are automatically entered by the personal portal when the user clicks on the link so that once the credentials have been saved to the personal portal, the user is not required to enter them again. This one-click launch functionality remains regardless of the type of device or browser from which the link is accessed.

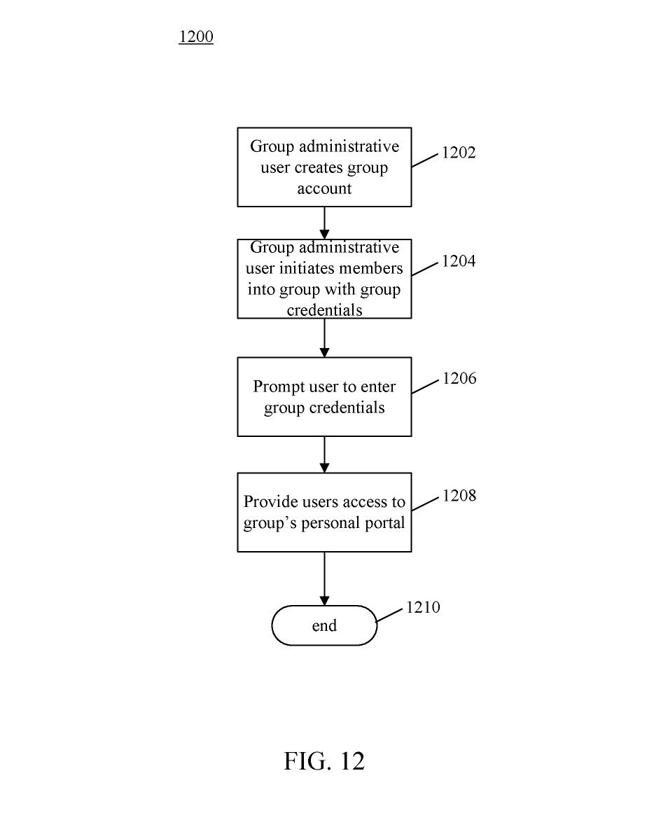

FIG. 12 is a flowchart 1200 of a fourth use case scenario for the use of a personal portal web service in accordance with an example embodiment. Flowchart 1200 of FIG. 12 begins in step 1202 when a group administrative user creates a group account that can include up to certain number of users. The group administrative user initiates members into the group with group credentials in step 1204. In step 1206, a member of the group is prompted to enter their group credentials. Once the user's group credentials are entered, the scenario proceeds to step 1208 wherein the user is provided access to the group's personal portal which provides access to the group's preferences, websites and resources. In the group portal scenario, each user may have only read permission or full control on the group portal page depending on what level of permission the group administrator assigns to each member in step 1204. Thus, each user in the group can access the same group portal created for them by simply entering their group credentials and their access can be partial or whole depending upon the user. Flowchart 1200 of FIG. 12 ends in step 1210. In accordance with an alternate embodiment, the group administrative user is enabled to issue a unique set of credentials to each user within a group, and each user can use his or her unique credentials to access the group's personal portal. In another alternate embodiment, the group administrative user is enabled to set a unique set of rules and/or policies for each user within a group, and each user can access certain resources of the group's portal based on their role-based permissions.

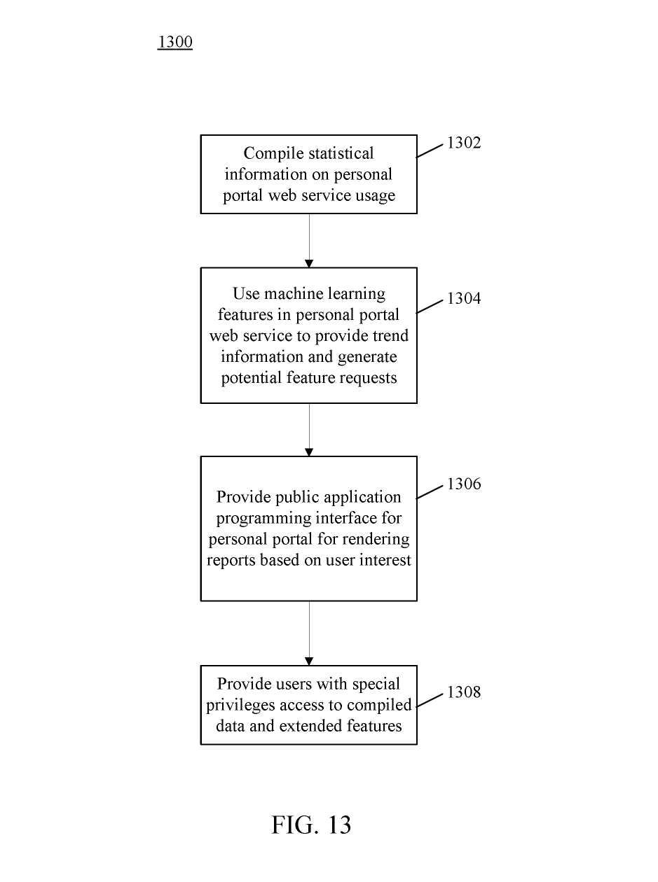

FIG. 13 is a flowchart 1300 of a fifth use case scenario for the use of a personal portal web service in accordance with an example embodiment. Flowchart 1300 is directed toward extended features of the personal portal that can be provided to certain advanced or paid users of the system. The extended features can preferably be selected and customized by users. Flowchart 1300 begins in step 1302 with the compiling of statistical information on usage of the personal portal web service. Machine learning features in the personal portal web service are then used to analyze the compiled statistical information, provide trend information and generate potential feature requests as shown in step 1304. A public application programming interface is provided in step 1306 for the personal portal that allows users to develop applications and render reports based on user specified interests. Flowchart 1300 of FIG. 13 ends in step 1308 where users with special privileges are provided access to the compiled data and extended features. This allows administrators or users with privilege to view stats of websites that are being bookmarked and other statistical information through the graphical user interface.

### Example Computer System Implementation

FIG. 14 depicts an example processor-based computer system 1400 that may be used to implement various embodiments described herein. For example, system 1400 may be used to implement server 112 as described above in reference to FIG. 1 or to execute any of the components of the program logic 300 as described above in reference to FIG. 3. System 1400 may also be used to implement any or all the steps of any or all the flowcharts depicted in FIGS. 4-13. The description of system 1400 provided herein is provided for purposes of illustration, and is not intended to be limiting. Embodiments may be implemented in further types of computer systems, as would be known to persons skilled in the relevant art(s).

As shown in FIG. 14, system 1400 includes a processing unit 1402, a system memory 1404, and a bus 1406 that couples various system components including system memory 1404 to processing unit 1402. Processing unit 1402 may comprise one or more microprocessors or microprocessor cores. Bus 1406 represents one or more of any of several types of bus structures, including a memory bus or memory controller, a peripheral bus, an accelerated graphics port, and a processor or local bus using any of a variety of bus architectures. System memory 1404 includes read only memory (ROM) 1408 and random access memory (RAM) 1410. A basic input/output system 1412 (BIOS) is stored in ROM 1408.

System 1400 also has one or more of the following drives: a hard disk drive 1414 for reading from and writing to a hard disk, a magnetic disk drive 1416 for reading from or writing to a removable magnetic disk 1418, and an optical disk drive 1420 for reading from or writing to a removable optical disk 1422 such as a CD ROM, DVD ROM, BLU-RAY™ disk or other optical media. Hard disk drive 1414, magnetic disk drive 1416, and optical disk drive 1420 are connected to bus 1406 by a hard disk drive interface 1424, a magnetic disk drive interface 1426, and an optical drive interface 1428, respectively. The drives and their associated computer-readable media provide nonvolatile storage of computer-readable instructions, data structures, program modules and other data for the computer. Although a hard disk, a removable magnetic disk and a removable optical disk are described, other types of computer-readable memory devices and storage structures can be used to store data, such as flash memory cards, digital video disks, random access memories (RAMs), read only memories (ROM), and the like.

A number of program modules or components may be stored on the hard disk, magnetic disk, optical disk, ROM, or RAM. These program modules include an operating system 1430, one or more application programs 1432, other program modules 1434, and program data 1436. In accordance with various embodiments, the program modules may include computer program logic that is executable by processing unit 1402 to perform any or all the functions and features of server 112 as described above in reference to FIG. 1 or program logic 300 as described above in reference to FIG. 3. The program modules may also include computer program logic that, when executed by processing unit 1402, performs any of the steps or operations shown or described in reference to the flowcharts of FIGS. 4-13.

A user may enter commands and information into system 1400 through input devices such as a keyboard 1438 and a pointing device 1440. Other input devices (not shown) may include a microphone, joystick, game controller, scanner, or the like. In one embodiment, a touch screen is provided in conjunction with a display 1444 to allow a user to provide user input via the application of a touch (as by a finger or stylus for example) to one or more points on the touch screen. These and other input devices are often connected to processing unit 1402 through a serial port interface 1442 that is coupled to bus 1406, but may be connected by other interfaces, such as a parallel port, game port, or a universal serial bus (USB). Such interfaces may be wired or wireless interfaces.

A display 1444 is also connected to bus 1406 via an interface, such as a video adapter 1446. In addition to display 1444, system 1400 may include other peripheral output devices (not shown) such as speakers and printers.

System 1400 is connected to a network 1448 (e.g., a local area network or wide area network such as the Internet via cable/fiber/cellular networks such as Long-Term-Evolution (LTE)) through a network interface or adapter 1450, a modem 1452, or other suitable means for establishing communications over the network. Modem 1452, which may be internal or external, is connected to bus 1406 via serial port interface 1442. As used herein, the terms “computer program medium,” “computer-readable medium,” and “computer-readable storage medium” are used to generally refer to memory devices or storage structures such as the hard disk associated with hard disk drive 1414, removable magnetic disk 1418, removable optical disk 1422, as well as other memory devices or storage structures such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 1432 and other program modules 1434) may be stored on the hard disk, magnetic disk, optical disk, ROM, or RAM. Such computer programs may also be received via network interface 1450, serial port interface 1442, or any other interface type. Such computer programs, when executed or loaded by an application, enable computer 1400 to implement features of embodiments of the present invention discussed herein. Accordingly, such computer programs represent controllers of the system 1400.

Embodiments are also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to memory devices and storage structures such as RAM, hard drives, floppy disks, CD ROMs, DVD ROMs, zip disks, tapes, magnetic storage devices, optical storage devices, MEMs, nanotechnology-based storage devices, and the like.

In alternative implementations, system 1400 may be implemented as hardware logic/electrical circuitry or firmware. In accordance with further embodiments, one or more of these components may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### Additional Exemplary Embodiments

In an embodiment, a system includes at least one memory configured to store program logic and at least one processor configured to access the at least one memory and to execute the program logic. The program logic includes a preferred website uploader that uploads from a remote device internet bookmark data that identifies preferred websites for a user. A data store stores the internet bookmark data. A graphical user interface provider provides a graphical user interface that enables the user to connect to the preferred websites identified by the internet bookmark data stored in the data store.

In an embodiment, the graphical user interface functions as a home page for a web browser of the user.

In an embodiment, the program logic further comprises a log on routine that receives and verifies log on information for a user account associated with the user and logs the user into the user account.

In an embodiment, the graphical user interface further enables the user to access remotely-hosted applications associated with the user account.

In an embodiment, the program logic further comprises an authentication data store that stores user authentication data for the user.

In an embodiment, the graphical user interface is operable to display the authentication data when the user is logged into the user account.

In an embodiment, the program logic comprises a credential applier that automatically enters the authentication data into a remote application accessed by the user through the graphical user interface.

In an embodiment, the graphical user interface is organized in accordance with a graphical user interface theme that specifies a logical layout for the graphical user interface, the graphical user interface being selected by the user from among a plurality of graphical user interface themes.

In an embodiment, a synchronizer synchronizes the internet bookmark data stored in the data store with internet bookmark data stored on the remote device.

In an embodiment, the program logic further comprises an access manager that enables the user to provide group access to the graphical user interface.

In an embodiment, the program logic further comprises an updater that allows the user to make changes to the internet bookmark data.

In an embodiment, a method includes uploading internet bookmark data from a remote device associated with a user. The internet bookmark data is stored in a data store. A graphical user interface is provided that allows the user to connect to preferred websites specified by the internet bookmark data stored in the data store.

In an embodiment, log on information for a user account associated with the user is received and verified and the user is logged into the user account.

In an embodiment, user authentication data for a website is stored in the data store. Access to the user authentication data is provided to the user when the user is logged into the user account.

In an embodiment, access is provided through the graphical user interface to a remote application.

In an embodiment, a publicly accessible uniform resource locator is generated that can be used to access the graphical user interface.

In an embodiment, at least one difference is detected between internet bookmark data stored on the remote device associated with the user and the internet bookmark data stored in the data store. In response to detecting the at least one difference, the internet bookmark data stored in the data store is synchronized with the internet bookmark data stored on the remote device associated with the user.

In an embodiment, statistical data concerning use of the graphical user interface by the user and other graphical user interfaces by other users is collected and stored and restricted access is provided to the statistical data.

In an embodiment, usage data concerning use of the graphical user interface by the user and other graphical user interfaces by other users is collected and stored that can be accessed by users with advanced access credentials. Machine learning is used to process the usage data, provide trend information, make recommendations, and generate potential feature requests. An application programming interface is provided via which at least one applications can access the usage data.

In an embodiment, a system includes at least one memory configured to store program logic and at least one processor configured to access the at least one memory and to execute the program logic. The program logic includes a preferred website uploader that uploads from a remote device internet preferences data that identifies internet preferences for a user. A data store stores the internet preferences data. A graphical user interface provider provides a graphical user interface that allows the user to connect to at least one of a preferred website and a remotely hosted application identified by the internet preferences data and an authentication data graphical user interface that allows the user to enter authentication data for at least one of a preferred website and a remotely hosted application. An authentication data store stores the authentication data. A credential applier automatically enters the authentication data into a remotely hosted application or preferred website.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A system, comprising:
at least one memory configured to store program logic; and
at least one processor configured to access the at least one memory and to execute the program logic, the program logic comprising:
a preferred website uploader that uploads from a remote device internet bookmark data that identifies preferred websites for a user;
a data store that stores the internet bookmark data; and
a graphical user interface provider that provides a graphical user interface that enables the user to connect to the preferred websites identified by the internet bookmark data stored in the data store.

2. The system of claim 1, wherein the graphical user interface functions as a home page for a web browser of the user.

3. The system of claim 1, wherein the program logic further comprises a log on routine that receives and verifies log on information for a user account associated with the user and logs the user into the user account.

4. The system of claim 3, wherein the graphical user interface further enables the user to access remotely-hosted applications associated with the user account.

5. The system of claim 3, wherein the program logic further comprises an authentication data store that stores user authentication data for the user.

6. The system of claim 5, wherein the graphical user interface is operable to display the authentication data when the user is logged into the user account.

7. The system of claim 5, wherein the program logic comprises a credential applier that automatically enters the authentication data into a remote application accessed by the user through the graphical user interface.

8. The system of claim 1, wherein the graphical user interface is organized in accordance with a graphical user interface theme that specifies a logical layout for the graphical user interface, the graphical user interface theme being selected by the user from among a plurality of graphical user interface themes.

9. The system of claim 1, further comprising a synchronizer that synchronizes the internet bookmark data stored in the data store with internet bookmark data stored on the remote device.

10. The system of claim 1, wherein the program logic further comprises an access manager that enables the user to provide group access to the graphical user interface.

11. The system of claim 1, wherein the program logic further comprises an updater that allows the user to make changes to the internet bookmark data.

12. A method, comprising:
uploading internet bookmark data from a remote device associated with a user;
storing the internet bookmark data in a data store; and
providing a graphical user interface that allows the user to connect to preferred websites specified by the internet bookmark data stored in the data store.

13. The method of claim 12, further comprising:
receiving and verifying log on information for a user account associated with the user; and
logging the user into the user account.

14. The method of claim 13, further comprising:
storing user authentication data for a website in the data store; and
providing access to the user authentication data to the user when the user is logged into the user account.

15. The method of claim 12, further comprising providing access through the graphical user interface to a remote application.

16. The method of claim 12, further comprising:
generating a publicly accessible uniform resource locator that can be used to access the graphical user interface.

17. The method of claim 12, further comprising:
detecting at least one difference between internet bookmark data stored on the remote device associated with the user and the internet bookmark data stored in the data store; and
in response to detecting the at least one difference, synchronizing the internet bookmark data stored in the data store with the internet bookmark data stored on the remote device associated with the user.

18. The method of claim 12, further comprising:
collecting and storing statistical data concerning use the graphical user interface by the user and other graphical user interfaces by other users and providing restricted access to the statistical data.

19. The method of claim 12, further comprising:
collecting and storing usage data concerning use of the graphical user interface by the user and other graphical user interfaces by other users that can be accessed by users with advanced access credentials;
using machine learning to process the usage data, provide trend information and generate potential feature requests; and
providing an application programming interface via which at least one application can access the usage data.

20. A system, comprising:
at least one memory configured to store program logic; and
at least one processor configured to access the at least one memory and to execute the program logic, the program logic comprising:
a preferred website uploader that uploads from a remote device internet preferences data that identifies internet preferences for a user;
a data store that stores the internet preferences data;
a graphical user interface provider that provides a graphical user interface that allows the user to connect to at least one of a preferred website and a remotely hosted application identified by the internet preferences data and an authentication data graphical user interface that allows the user to enter authentication data for at least one of a preferred website and a remotely hosted application;
an authentication data store that stores the authentication data; and
a credential applier that automatically enters the authentication data into a remotely hosted application or preferred website accessed by the user.
